(19) United States
(12) Patent Application Publication
(10) Pub. No.: US 2020/0305187 A1
(43) Pub. Date: Sep. 24, 2020

(54) USER EQUIPMENT, BASE STATION, AND SIGNAL TRANSMISSION OR RECEPTION METHOD

(71) Applicant: NTT DOCOMO, INC., Tokyo (JP)

(72) Inventors: Kazuaki Takeda, Tokyo (JP); Yousuke Sano, Tokyo (JP); Kazuki Takeda, Tokyo (JP); Satoshi Nagata, Tokyo (JP); Qin Mu, Beijing (CN); Liu Liu, Beijing (CN)

(73) Assignee: NTT DOCOMO, INC., Tokyo (JP)

(21) Appl. No.: 16/088,780

(22) PCT Filed: Mar. 30, 2017
(86) PCT No.: PCT/JP2017/013149

§ 371 Date: Sep. 26, 2018

(30) Foreign Application Priority Data
Mar. 31, 2016 (JP) 2016-073458

(51) Int. Cl. H04W 74/00; H04W 74/08; H04W 72/12

(52) U.S. Cl. CPC H04W 74/006; H04W 74/004; H04W 48/08; H04W 72/1289; H04W 72/1268; H04W 74/0833

(57) ABSTRACT

A user equipment is disclosed including a processor that selects a parameter set from a parameter set group generated by grouping radio parameters used for transmission of an uplink signal or reception of a downlink signal, and selects a radio parameter to be applied to the uplink signal or the downlink signal from the selected parameter set, and a transceiver that performs the transmission of the uplink signal or the reception of the downlink signal using the selected radio parameter.

### TECHNICAL FIELD

One or more embodiments disclosed herein relate to a user equipment, a base station, and a signal transmission or reception method.

### BACKGROUND

In a Universal Mobile Telecommunications System (UMTS) network, Long Term Evolution (LTE) has been specified for the purposes of a higher data rate, a low delay, and so on (Non-Patent Document 1). Further, succeeding systems of LTE (for example, LTE-Advanced (LTE-A), Future Radio Access (FRA), 4G, 5G, and so on) are under discussion for the purposes of a wider band and a higher speed than LTE.

In the succeeding systems of LTE, it is necessary to support always-connected cloud services and simultaneous connection of a plurality of terminals represented by Internet of things (IoT). Particularly, in Third Generation Partnership Project (3GPP), standardization related to optimization of machine type communication (MTC) is under discussion as a cellular system for machine-to-machine (M2M) communication in which devices connected to a network perform communication with each other without human intervention for automatic control (Non-Patent Document 2). An MTC terminal (MTC user equipment (UE)) is expected to be used in a wide range of fields such as electric meters, gas meters, vending machines, vehicles, or other industrial equipment, and in the future, the number of simultaneously-connected terminals is expected to increase dramatically.

Further, in the succeeding systems of LTE, it is required to increase a data transmission rate as well. For example, in 5G, it is required to realize a data transmission rate which is about 100 times higher than that of LTE. In order to support such high-speed data transmission and reduce costs, it is necessary to support various terminal categories such as MTC terminals in which transmission and reception bandwidths are limited.

As another example, since MTC terminals are likely to be placed in areas such as deep areas of buildings or basements in which indoor penetration loss is large and it is difficult to perform radio communication, in the succeeding systems of LTE, coverage extension is also required.

Furthermore, it is necessary to provide such high performance in a low cost and low power network.

Particularly, considering that MTC terminals will be widely used, a lower cost and a longer battery life are also required from the viewpoint of the terminals.

### PRIOR ART DOCUMENTS

### Non-Patent Documents

Non-Patent Document 1: 3GPP TS 36.300 “Evolved Universal Terrestrial Radio Access (E-UTRA) and Evolved Universal Terrestrial Radio Access Network (E-UTRAN); Overall description; Stage 2”

Non-Patent Document 2: 3GPP TS 36.888 “Study on provision of low-cost Machine-Type Communications (MTC) User Equipments (UEs) based on LTE (Release 12)”

### SUMMARY

According to one aspect, embodiments disclosed herein include a user equipment including a processor that selects a parameter set from a parameter set group generated by grouping radio parameters used for transmission of an uplink signal or reception of a downlink signal, and selects a radio parameter to be applied to the uplink signal or the downlink signal from the selected parameter set, and a transceiver that performs the transmission of the uplink signal or the reception of the downlink signal using the selected radio parameter.

### BRIEF DESCRIPTION OF DRAWINGS

FIG. 1 is a diagram illustrating an exemplary configuration of a radio communication system according to an embodiment of the present invention;

FIG. 2 is a sequence diagram illustrating an example of a processing procedure of a radio communication system according to an embodiment of the present invention;

FIG. 3 is a diagram illustrating an example of a relationship between parameter sets and PRACH resources;

FIG. 4 is a diagram illustrating an example of a relationship between parameter sets and time/frequency resource groups;

FIG. 5 is a diagram illustrating a configuration example of time/frequency resources for reducing collisions;

FIG. 6 is a diagram illustrating an exemplary functional configuration of a user equipment according to an embodiment of the present invention;

FIG. 7 illustrates an exemplary functional configuration of a base station according to an embodiment of the present invention;

FIG. 8 is a diagram illustrating an exemplary hardware configuration of a user equipment according to an embodiment of the present invention; and

FIG. 9 is a diagram illustrating an exemplary hardware configuration of a base station according to an embodiment of the present invention.

### DETAILED DESCRIPTION OF THE PREFERRED EMBODIMENTS

Hereinafter, an exemplary embodiment of the present invention will be described with reference to the accompanying drawings. An embodiment to be described below is merely an example, and an embodiment to which the present invention is applied is not limited to the following embodiment. For example, a radio communication system of the present embodiment is assumed to be a system complying with LTE/LTE-A, but the present invention is not limited to LTE/LTE-A and is also applicable to other systems. In this specification and claims set forth below, “LTE/LTE-A” is used in a broad sense including not only a communication system corresponding to Release 8 or 9 of 3GPP but also a communication system corresponding to Release 10, 11, 12, or 13 of 3GPP or a fifth generation communication system corresponding to any release subsequent to Release 14 of 3GPP.

<System Configuration>

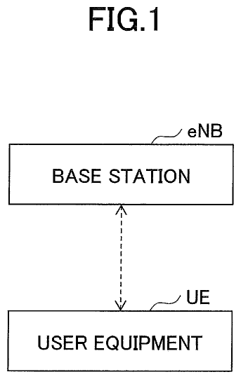

FIG. 1 is a diagram illustrating an exemplary configuration of a radio communication system according to an embodiment of the present invention. As illustrated in FIG. 1, the radio communication system according to the embodiment of the present invention includes a base station eNB and a user equipment UE. In the example of FIG. 1, one base station eNB and one user equipment UE are illustrated, but a plurality of base station eNBs or a plurality of user equipments UEs may be provided.

The base station eNB and the user equipment UE perform downlink (DL) communication and uplink (UL) communication using a predetermined band. The predetermined band may be a system band of LTE/LTE-A (for example, 20 MHz) or may be a narrower band (for example, 1.4 MHz or 180 kHz) than the system band of LTE/LTE-A.

For example, it is under consideration to apply, compared to the existing terminal (LTE terminal), a reduction of a peak rate, a restriction of a transport block size, a restriction of a resource block (which is also referred to as a RB or a physical resource block (PRB)), a restriction of a reception RF, and so on to a low cost (LC) MTC terminal (LC-MTC UE) that can be implemented by a simple hardware configuration among MTC terminals. The low cost MTC terminal may be simply called an MTC terminal (hereinafter, referred to as an “MTC terminal”). Further, the existing terminal may be called a normal UE, a non-MTC UE, or the like. Unlike the existing user terminal in which an upper limit of the frequency band is set to the system band (for example, 20 MHz (100 RB), one component carrier, or the like), an upper limit of the frequency band of the MTC terminal is limited to a predetermined band (for example, 1.4 MHz (6 RB)). It is under consideration to operate the band-limited MTC terminal within the system band of LTE/LTE-A in view of compatibility with the existing terminal.

Further, for example, an MTC terminal capable of further reducing costs by further applying further applying restrictions to the frequency band among MTC terminals is under discussion. A work item (WI) related to this discussion is called narrow band-Internet of things (NB-IoT). In NB-IoT, an upper limit of the frequency band is limited to a narrower band (for example, 180 kHz). A terminal whose frequency band is further limited in this manner may be called an NB-IoT terminal or simply called an MTC terminal. The frequency band may be arranged in anywhere within a band that can be actually used for transmission and reception in the system band of LTE/LTE-A, may be arranged in a band corresponding to a guard band in the system band of LTE/LTE-A, or may be arranged in a band dedicated to NB-IoT.

The MTC terminal or the NB-IoT terminal may be expressed as a terminal whose maximum supported band is a part of the system band or as a terminal having a capability of transmission/reception with a band narrower than the system band of LTE/LTE-A.

The user equipment UE receives downlink control information (DCI) using a downlink control channel arranged in a predetermined band, and the downlink control channel may be called an enhanced physical downlink control channel (EPDCCH) or may be called an MTC PDCCH (MPDCCH) particularly in the case of the MTC terminal.

Further, the user equipment UE receives downlink data using a downlink shared channel (a downlink data channel) arranged in a predetermined band, and the downlink shared channel may be called a physical downlink shared channel (PDSCH) or may be called an MTC PDSCH (MPDSCH) particularly in the case of the MTC terminal.

Further, the user equipment UE transmits uplink data using an uplink shared channel (an uplink data channel) arranged in a predetermined band, and the uplink shared channel may be called a physical uplink shared channel (PUSCH) or may be called an MTC PUSCH (MPUSCH) particularly in the case of the MTC terminal.

Further, a physical uplink control channel (PUCCH) for the MTC terminal may be called an MTC PUCCH (MPUCCH). Channels used by the MTC terminal are not limited to these channels and may be indicated by attaching “M” representing MTC to the conventional channels used for the same purpose.

The user equipment UE according to the embodiment of the present invention is not limited to the MTC terminal or the NB-IoT terminal but may be any device capable of communicating with the base station eNB.

In the case where a plurality of terminals are simultaneously connected to a base station, there is a problem that control information for data transmission/reception increases.

A user selected by the base station through scheduling is allocated a radio resource through a physical downlink control channel (PDCCH). Scheduling information is included in the PDCCH, and the scheduling information is called DL scheduling information or DL assignment in the downlink and called a UL grant in the uplink. The control information includes a location of the radio resource, a modulation scheme, a data size (a transport block size (TBS)), a command for transmission power control, and so on. As the number of simultaneously-connected terminals increases, the control information is expected to increase.

In NB-IoT, in particular, in order to improve a coverage area in a cellular system, a base station is supposed to repeatedly transmit the control information, and a terminal is supposed to combine power of received signals. However, when the PDCCH is transmitted each time the base station repeatedly transmits the control information, the overhead of the PDCCH increases, and the frequency usage efficiency decreases.

The problem in that the control information increases can occur not only in NB-IoT but also in a radio communication system in which simultaneous connection of a plurality of terminals is supported.

In view of the problem, an embodiment of the present invention aims to reduce control information for data transmission/reception.

<Processing Procedure>

In the embodiment of the present invention, radio parameters (for example, a modulation scheme/channel coding rate (modulation and coding scheme (MCS)), a transport block size (TBS), transmission power (Tx Power), radio resources (a time resource, a frequency resource, and/or a code resource), identifiers (a UE-ID and/or a group UE-ID) (for example, a cell radio network temporary identifier (C-RNTI) and so on) used for transmission or reception of signals are grouped, and a parameter set group (for example, a parameter set 1, a parameter set 2, a parameter set 3, and a parameter set 4) is provided in advance.

A signal to which the radio parameters are applied may be an uplink signal or a downlink signal. Further, uplink data or downlink data or the control information may be included in the signal to which the radio parameters are applied.

For example, (modulation scheme=QPSK, coding rate (×1024)=78) and (modulation scheme=QPSK, coding rate (×1024)=193) may be provided in the parameter set 1 as the MCS, and (modulation scheme=QPSK, coding rate (×1024)=449), (modulation scheme=16QAM, coding rate (×1024)=378), and (modulation scheme=16QAM, coding rate (×1024)=490) may be provided in the parameter set 2 as the MCS. The radio parameters may be designated by specific values or may be designated by index values. Further, the number of radio parameters included in one parameter set may be one or more. Further, the same radio parameter (for example, (modulation scheme=QPSK, coding rate (×1024)=449)) may be included in a plurality of parameter sets.

When the base station transmits/receives a signal to/from the user equipment UE, the base station eNB selects one radio parameter from the parameter set and notifies the user equipment UE of the selected radio parameter through the downlink control information (DCI), and thus the amount of the downlink control information can be reduced. For example, when one MCS is designated among 29 MCSs through the DCI, at least 5 bits are required. On the other hand, for example, when the parameter set 1 including two MCSs is determined to be used before the notification of the DCI, it is possible to reduce the amount of information designating the MCS through the DCI up to one bit.

Furthermore, when the number of MCSs included in the parameter set is one, it is also possible to eliminate the amount of information for designating the MCS through the DCI.

A specific processing procedure will be described below.

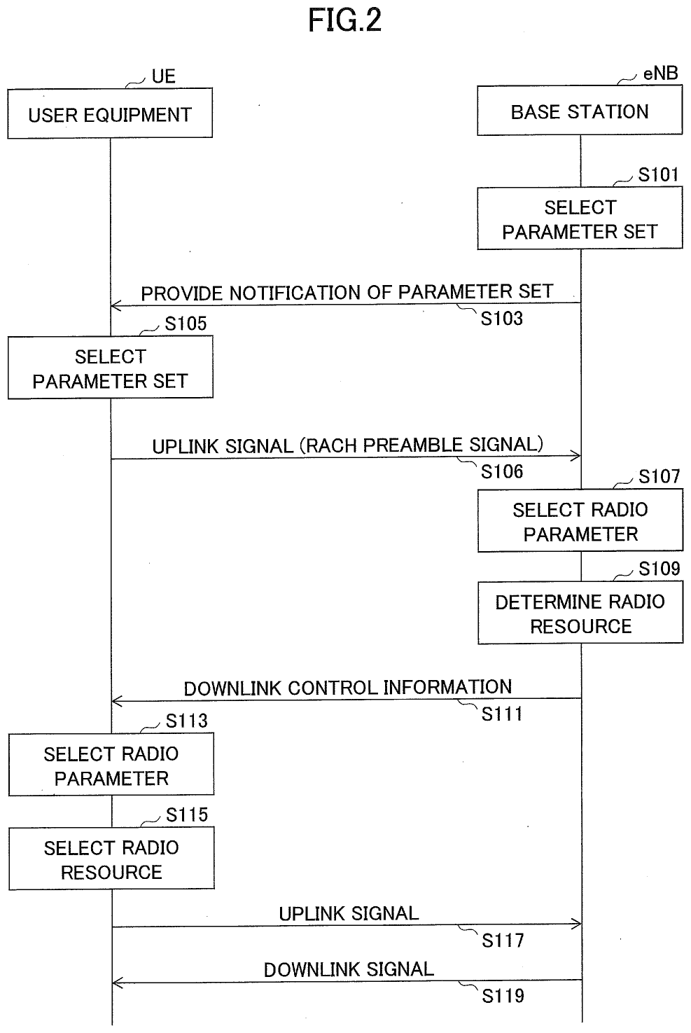

FIG. 2 is a sequence diagram illustrating an example of a processing procedure of the radio communication system according to an embodiment of the present invention.

A parameter set group is generated by grouping radio parameters in advance. The parameter set group may be determined in the system in advance, or a notification of the parameter set group may be provided from the base station eNB to the user equipment UE through a higher layer signal (for example, a system information block (SIB)).

Then, a parameter set is selected from the parameter set group. The selection of the parameter set may be performed by the base station eNB or may be performed by the user equipment UE. Further, the parameter set may be associated with a coverage level (for example, reference signal received power (RSRP), reference signal received quality (RSRQ), a path loss, or a signal to interference plus noise ratio (SINR)). The coverage level may indicate a (rough) location of the user equipment UE in the cell of the base station eNB, a distance from the base station eNB to the user equipment UE, or reception quality. A relationship between the coverage level and the parameter set (for example, a threshold value of the coverage level used for determining whether the parameter set 1 or the parameter set 2 is used) may be determined in the system in advance, and a notification of the relationship may be provided from the base station eNB to the user equipment UE through the higher layer signal (for example, the SIB).

Alternatively, the parameter set may be associated with a packet size. The packet size may indicate a data amount in a transmission buffer. A relationship between the packet size and the parameter set (for example, a threshold value of the packet size used for determining whether the parameter set 1 or the parameter set 2 is used) may be determined in the system in advance, and a notification of the relationship may be provided from the base station eNB to the user equipment UE through the higher layer signal (for example, the SIB).

When a parameter set is selected by the base station eNB, the base station eNB selects the parameter set from the parameter set group (step S101) and notifies the user equipment UE of the selected parameter set (step S103). The parameter set may be selected based on the coverage level, the packet size, or the like.

For example, when a radio resource control (RRC) connection is established between the base station eNB and the user equipment UE, the base station eNB may select a parameter set based on a measurement report from the user equipment UE. Alternatively, for example, the base station eNB may select a parameter set to be applied to the uplink signal based on a buffer status report from the user equipment UE or may select a parameter set to be applied to the downlink signal based on a data amount in the base station eNB.

Then, the user equipment UE selects a parameter set from the parameter set group (step S105). When the notification of the parameter set selected by the base station eNB in steps S101 and S103 is provided, the user equipment UE may select the provided parameter set. Alternatively, the user equipment UE may select a parameter set based on the coverage level, the packet size, or the like without a notification from the base station eNB.

For example, when random access with the base station eNB is performed, the user equipment UE selects a PRACH resource for transmitting a physical random access channel (PRACH) based on a measurement result of the coverage level (for example, the RSRP, the RSRQ, the path loss, or the SINR). In this case, different PRACH resources are provided depending on the coverage level (for example, the RSRP, the RSRQ, the path loss, or the SINR).

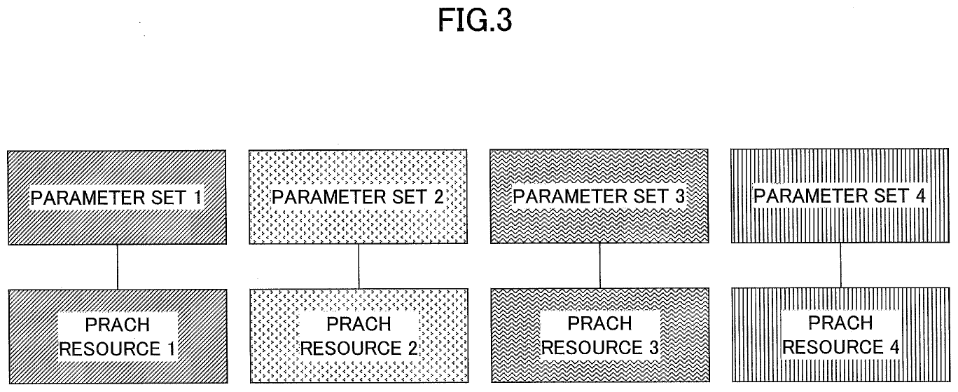

FIG. 3 is a diagram illustrating an example of the relationship between parameter sets and PRACH resources. A parameter set may be associated with a PRACH resource, and the user equipment UE may select a parameter set based on a PRACH resource. The relationship between parameter sets and PRACH resources may be determined in the system in advance, or a notification of the relationship may be provided from the base station eNB to the user equipment UE through the higher layer signal (for example, the SIB). Alternatively, for example, the user equipment UE may select a parameter set based on the data amount in the transmission buffer of the user equipment UE.

The user equipment UE compares the measured RSRP with the threshold value for determining the coverage level, selects a parameter set or a PRACH resource associated with the coverage level, and transmits a RACH preamble signal. Here, the threshold value for determining the coverage level may be determined in advance, or a notification of the threshold value may be provided from the base station eNB to the user equipment UE through the higher layer signal (for example, the SIB). Since the base station eNB can acquire the coverage level of the user equipment UE and information about a suitable parameter set based on the received PRACH resource, the base station eNB can appropriately select the parameter set to be used for a message 2 or later messages. FIG. 2 illustrates an example in which the base station eNB selects the parameter set and notifies the user equipment UE of the selected parameter set; however, the user equipment UE may select a parameter set and transmit the uplink signal (steps S105 and S106), and the base station eNB may determine a parameter set. In other words, steps S101 and S107 to S109 may be performed after steps S105 and S106 in FIG. 2. In this case, since the parameter set is selected by the user equipment UE in advance, the notification of the parameter set from the base station eNB to the user equipment UE may not be provided.

For example, before the RRC connection is established, the user equipment UE may select a parameter set (step S105), and after the RRC connection is established, the base station eNB may select a parameter set and notify the user equipment UE of the parameter set (steps S101 to S105). Alternatively, regardless of the establishment of the RRC connection, the user equipment UE may select a parameter set, or the base station eNB may select a parameter set and notify the user equipment UE of the parameter set.

Then, the base station eNB selects a radio parameter from the parameter set selected in step S101 (step S107). Further, even if the base station eNB selects the parameter set based on the PRACH resource received from the user equipment UE, the base station eNB selects a radio parameter from the selected parameter set. While it is necessary for the base station eNB to determine a radio parameter (for example, an MCS, a TBS, transmission power, or the like) for transmission or reception of a signal, the radio parameter is selected from the selected parameter set.

Further, the base station eNB determines a radio resource (for example, the time/frequency resource) for transmission or reception of the signal (step S109). For example, even if signals of a plurality of user equipments are multiplexed on the same radio resource using a technique called non-orthogonal multiple access (NOMA), the base station eNB can separate the signals, for example, using a path loss difference through a receiver equipped with an interference canceller. However, in order to reduce interference, it is desirable to determine the radio resource from the radio resource group specific to the parameter set.

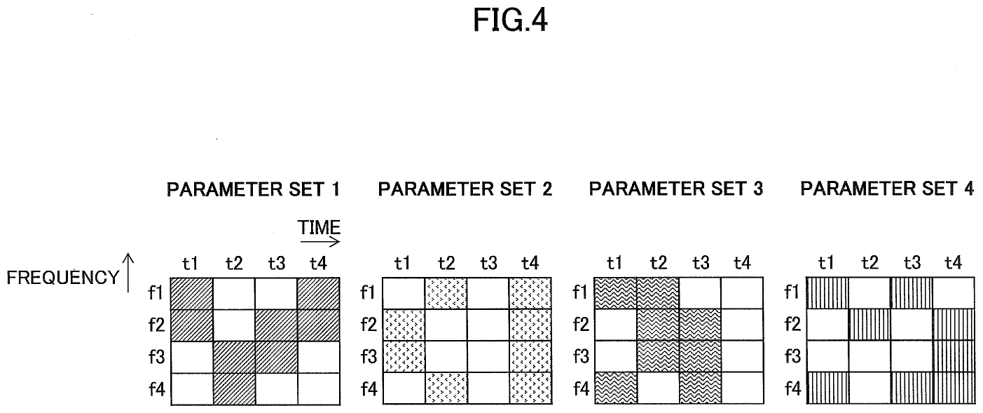

FIG. 4 is a diagram illustrating an example of a relationship between parameter sets and time/frequency resource groups. Different radio resource groups may be used for transmission or reception of a signal depending on the parameter set. There may be a radio resource which can be used in a plurality of parameter sets (for example, a time resource t1 with a frequency resource f1 can be used in the parameter sets 1, 3, and 4), or there may be a radio resource which can be used in only one parameter set (for example, a time resource t1 with a frequency resource f3 can be used only in the parameter set 2). Information indicating which radio resource can be used in the parameter set may be determined in the system in advance, the information may be included in the parameter set and reported to the user equipment UE through the higher layer signal (for example, the SIB), or the information may be reported to the user equipment UE through the higher layer signal (for example, the SIB) separately from the parameter set.

For example, as illustrated in FIG. 4, when the parameter set 1 is selected, the base station eNB determines a radio resource from the radio resource group including a time resource t1 with a frequency resource f1, the time resource t1 with a frequency resource f2, a time resource t2 with a frequency resource f3, the time resource t2 with a frequency resource f4, and so on.

When the parameter set is determined, the usable radio resource group is restricted. If a plurality of user equipments use the same radio resource, a collision occurs, leading to retransmission, or a complicated signal detection process in the base station eNB. Therefore, it is desirable that the base station eNB provide a radio resource specific to the user equipment UE so that a plurality of user equipments do not use the same radio resource whenever possible, in order to avoid retransmission or to apply an interference canceller suitable for NOMA.

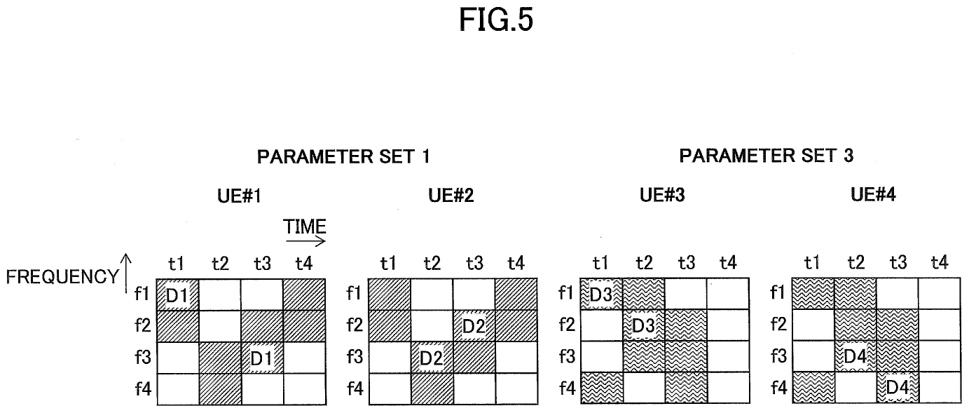

FIG. 5 is a diagram illustrating a configuration example of time/frequency resources for reducing collisions. For example, as illustrated in FIG. 5, a time resource t1 with a frequency resource f1 and a time resource t3 with a frequency resource f3 (indicated by D1 in FIG. 5) in the time/frequency resource group which can be used in the parameter set 1 are allocated to a user equipment UE #1 corresponding to the parameter set 1. The time resource t3 with a frequency resource f2 and a time resource t2 with the frequency resource f3 (indicated by D2 in FIG. 5) are allocated to a user equipment UE #2 corresponding to the parameter set 1. FIG. 5 illustrates an example in which different time/frequency resources are allocated to the user equipments UE #1 and UE #2 associated with the same parameter set 1, but one or more same time/frequency resources may be allocated to the user equipments UE #1 and UE #2.

A radio resource may be determined based on an identifier (UE-ID) specific to the user equipment UE (for example, the C-RNTI) from the radio resource group determined based on the parameter set. For example, a radio resource may be determined based on a calculation result of a hash function using the UE-ID. Further, in order to prevent the same user equipment UE from consistently using the same resource, a system frame number (SFN) may be used for the calculation of the hash function in addition to the UE-ID. Furthermore, a cell ID or the like may be used for the calculation of the hash function. The same time/frequency resource may be allocated to a plurality of user equipments according to a calculation result of the hash function.

Alternatively, a radio resource may be determined from the radio resource group determined based on the parameter set according to scheduling of the base station eNB. The base station eNB may allocate the same time/frequency resource to a plurality of user equipments or may allocate time/frequency resources so that the same time/frequency resource is not used by a plurality of user equipments.

The base station eNB notifies the user equipment UE of the radio parameter selected in step S107 and the radio resource determined in step S109 through downlink control information (DCI) (step S111). The DCI is called DL scheduling information or DL assignment in the downlink and called a UL grant in the uplink. Further, when the radio parameter is uniquely determined based on the parameter set, the base station eNB may not notify the user equipment UE of the radio parameter. Furthermore, as described below, if the user equipment UE can determine the radio resource using the same hash function as in the base station eNB, the base station eNB may not notify the user equipment of the radio resource. Further, transmission/reception of a signal to/from an arbitrary user equipment may be allowed in some radio resources, and the user equipment UE may transmit a signal without DCI from the base station eNB.

The base station eNB may scramble the downlink control information (DCI) using an identifier specific to the parameter set (hereinafter, referred to as an “RNTI specific to a parameter set”) selected in step S101.

Then, the user equipment UE selects a radio parameter from the parameter set selected in step S105 (step S113). When the notification of the radio parameter selected by the base station eNB in steps S107 and S109 is provided through the DCI, the user equipment UE may select the provided radio parameter. When the DCI is scrambled using the RNTI specific to the parameter set, the user equipment UE may perform descrambling using the RNTI specific to the parameter set corresponding to the parameter set selected in step S105. Furthermore, the RNTI specific to the parameter set may be derived from the radio parameters such as an index of the parameter set and a time, a frequency, and a code of a physical channel (the PDCCH or the PDSCH) used during a PRACH or RACH procedure. When the radio parameter is uniquely determined based on the parameter set, the user equipment UE may select the radio parameter uniquely determined based on the parameter set without a notification from the base station eNB.

Further, the user equipment UE selects a radio resource from the radio resource group specific to the parameter set selected in step S105 (step S115). When the notification of the radio resource selected by the base station eNB in steps S107 and S109 is provided through the DCI, the user equipment UE may select the provided radio resource.

On the other hand, as described above with reference to FIG. 5, the user equipment UE may select a radio resource based on the identifier (UE-ID) specific to the user equipment UE from the radio resource group determined based on the parameter set. For example, a radio resource may be determined based on a calculation result of the hash function using the UE-ID. Further, in order to prevent the same user equipment UE from consistently using the same resource, a system frame number (SFN) may be used for the calculation of the hash function in addition to the UE-ID. Furthermore, a cell ID or the like may be used for the calculation of the hash function.

As described above, when the radio parameter and the radio resource are determined, the user equipment UE transmits an uplink signal using the determined radio parameter and the radio resource, and the base station eNB receives the uplink signal using the determined radio parameter and the radio resource (step S117). Further, the base station eNB transmits a downlink signal using the determined radio parameter and the radio resource, and the user equipment UE receives the downlink signal using the determined radio parameter and the radio resource (step S119).

<Functional Configuration>

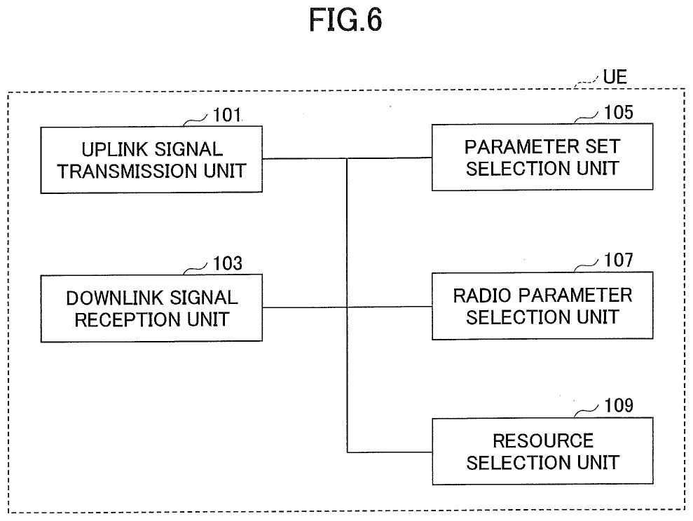

FIG. 6 is a diagram illustrating an exemplary functional configuration of a user equipment according to an embodiment of the present invention. As illustrated in FIG. 6, the user equipment UE includes an uplink signal transmission unit 101, a downlink signal reception unit 103, a parameter set selection unit 105, a radio parameter selection unit 107, and a resource selection unit 109. FIG. 6 illustrates only functional units of the user equipment UE particularly related to the embodiment of the present invention and also has a function (not illustrated) of performing operations at least complying with LTE/LTE-A. Further, the functional configuration illustrated in FIG. 6 is merely an example. Any functional classification or any functional unit name may be used as long as the operations according to this embodiment can be performed.

The uplink signal transmission unit 101 has a function of generating various kinds of uplink signals to be transmitted from the user equipment UE and transmitting the uplink signals. As described above with reference to FIGS. 2 to 5, the uplink signal transmission unit 101 transmits the uplink signal using the radio parameter selected from the parameter set.

The downlink signal reception unit 103 has a function of receiving various kinds of downlink signals from the base station eNB. As described above with reference to FIGS. 2 to 5, the downlink signal reception unit 103 receives the downlink signal using the radio parameter selected from the parameter set. The downlink signal from the base station eNB also includes downlink control information (DCI), and when the DCI is scrambled using an identifier specific to the parameter set, the downlink signal reception unit 103 receives the DCI using the identifier specific to the parameter set.

Each of the uplink signal transmission unit 101 and the downlink signal reception unit 103 includes a buffer and is assumed to perform the processes of the layer 1 (the physical (PHY) layer), the layer 2 (the media access control (MAC) layer, the radio link control (RLC) layer, and the packet data convergence protocol (PDCP) layer), and the layer 3 (the radio resource control (RRC) layer) (however, the present invention is not limited thereto).

The parameter set selection unit 105 selects the parameter set from the parameter set group generated by grouping the radio parameters used for transmission of the uplink signal or reception of the downlink signal. As described above with reference to FIGS. 2 to 5, the parameter set may be selected based on the coverage level, the packet size, or the like.

The radio parameter selection unit 107 selects the radio parameter to be applied to the uplink signal or the downlink signal from the selected parameter set. The notification of the radio parameter may be provided from the base station eNB through the downlink control information (DCI).

The resource selection unit 109 selects the radio resource used for transmission of the uplink signal or reception of the downlink signal. The radio resource may be selected from the radio resource group specific to the selected parameter set. Alternatively, the radio resource may be selected based on the calculation result of the hash function using the identifier specific to the user equipment UE from the radio resource group specific to the parameter set. Alternatively, the radio resource may be determined by the base station eNB, and the radio resource may be selected based on a notification from the base station eNB (for example, the notification using the DCI).

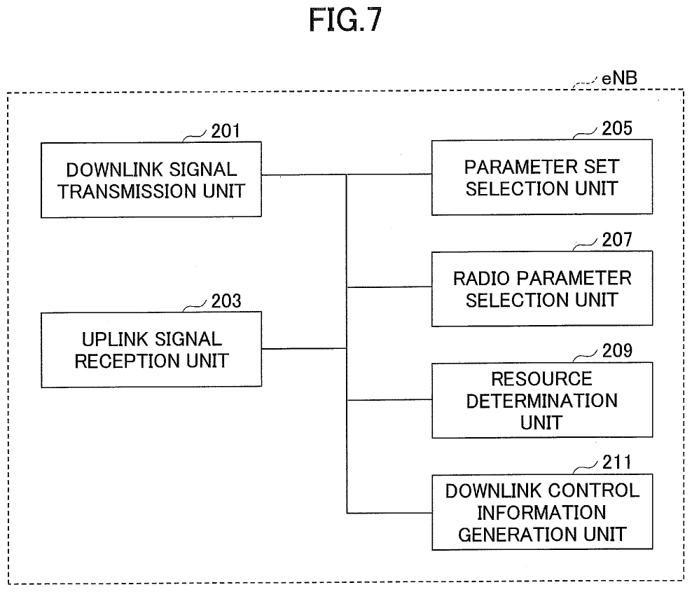

FIG. 7 is a diagram illustrating an exemplary functional configuration of a base station according to an embodiment of the present invention. As illustrated in FIG. 7, the base station eNB includes a downlink signal transmission unit 201, an uplink signal reception unit 203, a parameter set selection unit 205, a radio parameter selection unit 207, a resource determination unit 209, and a downlink control information generation unit 211. FIG. 7 illustrates only functional units of the base station eNB particularly related to the embodiment of the present invention, and also has a function (not illustrated) of performing operations at least complying with LTE/LTE-A. Further, the functional configuration illustrated in FIG. 7 is merely an example. Any functional classification or any functional unit name may be used as long as the operations according to this embodiment can be performed.

The downlink signal transmission unit 201 has a function of generating various kinds of downlink signals to be transmitted from the base station eNB and transmitting the downlink signals. As described above with reference to FIGS. 2 to 5, the downlink signal transmission unit 201 transmits the downlink signal using the radio parameter selected from the parameter set.

The uplink signal reception unit 203 has a function of receiving various kinds of uplink signals from the user equipment UE. As described with above reference to FIGS. 2 to 5, the uplink signal reception unit 203 receives the uplink signal using the radio parameter selected from the parameter set.

The parameter set selection unit 205 selects the parameter set from the parameter set group generated by grouping the radio parameters used for reception of the uplink signal or transmission of the downlink signal. As described above with reference to FIGS. 2 to 5, the parameter set may be selected based on the coverage level, the packet size, or the like.

The radio parameter selection unit 207 selects the radio parameter to be applied to the uplink signal or the downlink signal from the selected parameter set.

The resource determination unit 209 determines the radio resource for reception of the uplink signal or transmission of the downlink signal. The radio resource may be determined from the radio resource group specific to the selected parameter set. Alternatively, the radio resource may be determined based on the calculation result of the hash function using the identifier specific to the user equipment UE from the radio resource group specific to the parameter set. Alternatively, the radio resource may be determined according to scheduling of the base station eNB.

When the radio parameter and/or the radio resource are determined, the downlink control information generation unit 211 generates downlink control information (DCI) including the radio parameter and/or the radio resource. The DCI may be scrambled using an identifier specific to the parameter set.

The entire functional configuration of each of the base station eNB and the user equipment UE may be implemented by a hardware circuit (for example, one or more IC chips), or some of the functional units may implemented by a hardware circuit, and the remaining units may be implemented by a central processing unit (CPU) and a program.

<Hardware Configuration>

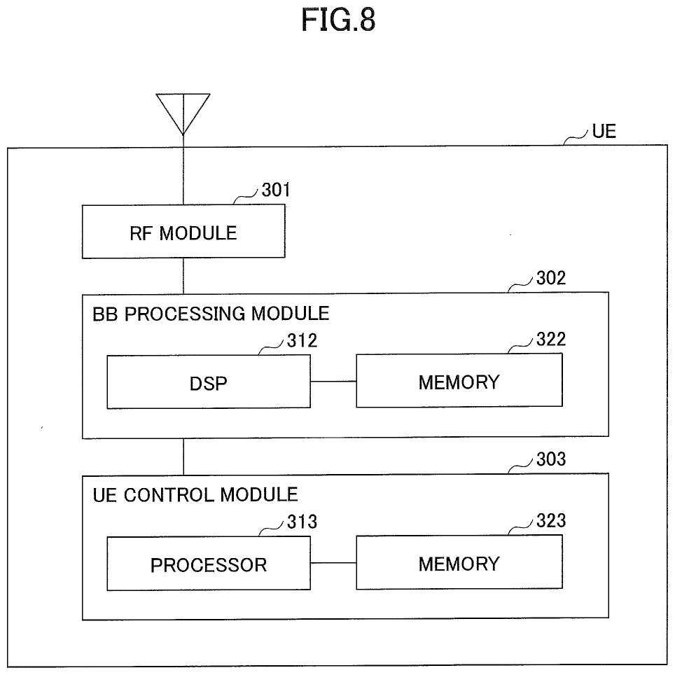

FIG. 8 is a diagram illustrating an exemplary hardware configuration of a user equipment according to an embodiment of the present invention. FIG. 8 illustrates a configuration that is closer to an implementation example than that of FIG. 6. As illustrated in FIG. 8, the user equipment UE includes a radio frequency (RF) module 301 that performs processing related to a radio signal, a baseband (BB) processing module 302 that performs baseband signal processing, and a UE control module 303 that performs processing of a higher layer or the like.

The RF module 301 performs digital-to-analog (D/A) conversion, modulation, frequency transformation, power amplification, and the like on a digital baseband signal received from the BB processing module 302 and generates a radio signal to be transmitted through an antenna. Further, the RF module 301 performs frequency transformation, analog-to-digital (A/D) conversion, demodulation, and the like on a received radio signal, generates a digital baseband signal, and transfers the digital baseband signal to the BB processing module 302. The RF module 301 includes, for example, a part of the uplink signal transmission unit 101 and a part of the downlink signal reception unit 103 illustrated in FIG. 6.

The BB processing module 302 performs a process of converting an IP packet into a digital baseband signal and vice versa. A digital signal processor (DSP) 312 is a processor that performs signal processing in the BB processing module 302. A memory 322 is used as a work area of the DSP 312. The BB processing module 302 includes, for example, a part of the uplink signal transmission unit 101 and a part of the downlink signal reception unit 103 illustrated in FIG. 6.

The UE control module 303 performs protocol processing of the IP layer, various kinds of application processing, and the like. A processor 313 is a processor that performs processing performed by the UE control module 303. A memory 323 is used as a work area of the processor 313. The UE control module 303 includes, for example, the parameter set selection unit 105, the radio parameter selection unit 107, and the resource selection unit 109 illustrated in FIG. 6.

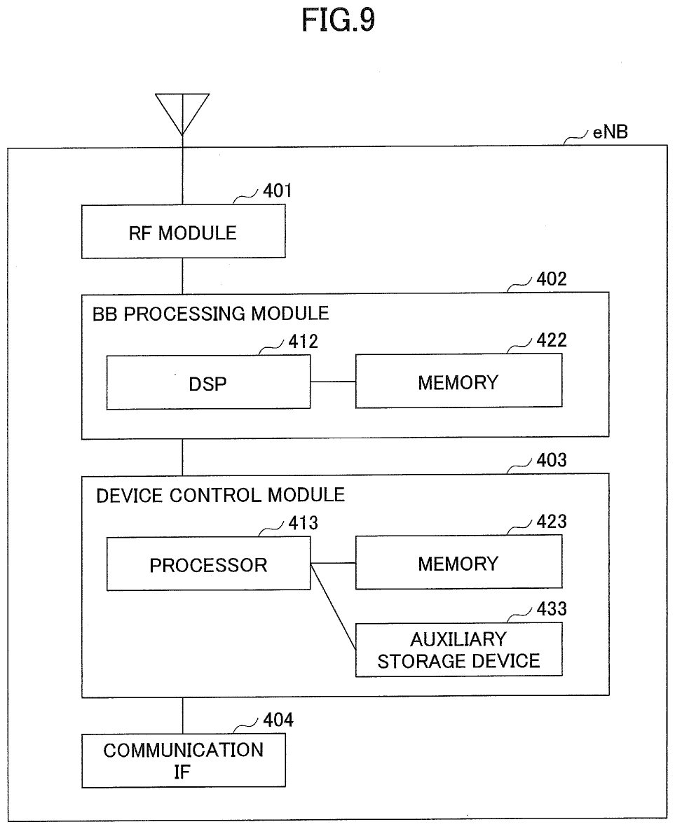

FIG. 9 is a diagram illustrating an exemplary hardware configuration of a base station according to an embodiment of the present invention. FIG. 9 illustrates a configuration that is closer to an implementation example than that of FIG. 7. As illustrated in FIG. 9, the base station eNB includes an RF module 401 which performs processing related to a radio signal, a BB processing module 402 which performs baseband signal processing, a device control module 403 which performs processing of the higher layer or the like, and a communication IF 404 which is an interface for a connection with a network.

The RF module 401 performs D/A conversion, modulation, frequency transformation, power amplification, and the like on a digital baseband signal received from the BB processing module 402 and generates a radio signal to be transmitted through an antenna. Further, the RF module 401 performs frequency transformation, A/D conversion, demodulation, and the like on a received radio signal, generates a digital baseband signal, and transfers the digital baseband signal to the BB processing module 402. The RF module 401 includes, for example, a part of the downlink signal transmission unit 201 and a part of the uplink signal reception unit 203 illustrated in FIG. 7.

The BB processing module 402 performs a process of converting an IP packet into a digital baseband signal and vice versa. A DSP 412 is a processor that performs signal processing in the BB processing module 402. A memory 422 is used as a work area of the DSP 412. The BB processing module 402 includes, for example, a part of the downlink signal transmission unit 201, a part of the uplink signal reception unit 203, and a part of the downlink control information generation unit 211 illustrated in FIG. 7.

The device control module 403 performs protocol processing of the IP layer, operation and maintenance (OAM) processing, and the like. A processor 413 is a processor that performs processing performed by the device control module 403. A memory 423 is used as a work area of the processor 413. An auxiliary storage device 433 is, for example, an HDD or the like, and stores various configuration information and the like for an operation of the base station eNB. The device control module 403 includes, for example, a part of the parameter set selection unit 205, the radio parameter selection unit 207, the resource determination unit 209, and the downlink control information generation unit 211 illustrated in FIG. 7.

### Effects of Embodiment of Present Invention

According to the embodiment of the present invention, it is possible to reduce control information for data transmission/reception. Even if the number of simultaneously-connected terminals increases, it is possible to reduce the bottleneck caused by the control information. Particularly, it is under consideration that the base station repeatedly transmits the control information to the MTC terminal, and even in this case, it is possible to reduce the control information.

Further, since the parameter set is associated with the coverage level, even when a plurality of user equipments use the same radio resource, signals can be easily separated using, for example, a path loss difference.

Furthermore, since the usable radio resources are limited by the parameter set, it is possible to reduce interference on the radio resources.

Moreover, since the radio resource is calculated by the base station and the user equipment using the hash function, it is possible to reduce collisions of the radio resources, and it is possible to further reduce control information between base station and the user equipment.

<Supplement>

As described above, the configuration of each device (the user equipment UE or the base station eNB) described in the embodiment of the present invention may be implemented by executing a program through a CPU (processor) in the device having the CPU and a memory, may be implemented by hardware such as a hardware circuit equipped with a processing logic described in the embodiment, or may be implemented by a combination of a program and hardware.

The exemplary embodiment of the present invention has been described above, but the disclosed invention is not limited to the described embodiment, and those skilled in the art would understand that various modified examples, revised examples, alternative examples, substitution examples, and the like can be made. In order to facilitate understanding of the invention, exemplary numerical values have been used for description, but the numerical values are merely examples, and any suitable values may be used unless otherwise stated. A classification of items in the above description is not essential to the present invention, matters described in two or more items may be combined and used as necessary, and a matter described in one item may be applied to a matter described in another item (unless inconsistent). The boundary between the functional units or the processing units in the functional block diagram does not necessarily correspond to the boundary between physical components. Operations of a plurality of functional units may be performed physically by one component, or an operation of one functional unit may be performed physically by a plurality of components. In the sequences and the flowcharts described in the embodiment, the order may be changed as long as there is no inconsistency. For the sake of convenience of description, the user equipment UE and the base station eNB have been described using the functional block diagrams, but such devices may be implemented by hardware, software, or a combination thereof. Software executed by the processor included in the user equipment UE according to the embodiment of the present invention and software executed by the processor included in the base station eNB according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

The technique of reducing control information for data transmission/reception has been described above, but an embodiment of the present invention is not limited to the described embodiment, and various modifications and applications are possible within the scope of claims set forth below.

The present international application is based on and claims the benefit of priority of Japanese Patent Application No. 2016-073458 filed on Mar. 31, 2016, the entire contents of which are hereby incorporated by reference.

### EXPLANATIONS OF REFERENCE NUMERALS

UE user equipment
eNB base station
101 uplink signal transmission unit
103 downlink signal reception unit
105 parameter set selection unit
107 radio parameter selection unit
109 resource selection unit
201 downlink signal transmission unit
203 uplink signal reception unit
205 parameter set selection unit
207 radio parameter selection unit
209 resource determination unit
211 downlink control information generation unit
301 RF module
302 BB processing module
303 UE control module
312 DSP
313 processor
322 memory
323 memory
401 RF module
402 BB processing module
403 device control module
404 communication IF
412 DSP
413 processor
422 memory
423 memory
433 auxiliary storage device

1. A user equipment, comprising:
a processor that selects a parameter set from a parameter set group generated by grouping radio parameters used for transmission of an uplink signal or reception of a downlink signal, and
selects a radio parameter to be applied to the uplink signal or the downlink signal from the selected parameter set; and
a transceiver that performs the transmission of the uplink signal or the reception of the downlink signal using the selected radio parameter.

2. The user equipment according to claim 1,
wherein the processor selects a radio resource for performing the transmission of the uplink signal or the reception of the downlink signal from a radio resource group specific to the selected parameter set.

3. The user equipment according to claim 2,
wherein the processor selects the radio resource based on a calculation result of a hash function using an identifier specific to the user equipment.

4. The user equipment according to claim 1,
wherein the transceiver receives the downlink signal including downlink control information scrambled using an identifier specific to the selected parameter set.

5. A base station, comprising:
a processor that selects a parameter set from a parameter set group generated by grouping radio parameters used for reception of an uplink signal or transmission of a downlink signal, and
selects a radio parameter to be applied to the uplink signal or the downlink signal from the selected parameter set; and
a transceiver that performs the reception of the uplink signal or the transmission of the downlink signal using the selected radio parameter.

6. The base station according to claim 5,
wherein the processor generates downlink control information including the selected radio parameter.

7. The base station according to claim 6,
wherein the processor scrambles the downlink control information using an identifier specific to the selected parameter set.

8. A signal transmission or reception method in a user equipment, comprising the steps of:
selecting a parameter set from a parameter set group generated by grouping radio parameters used for transmission of an uplink signal or reception of a downlink signal;
selecting a radio parameter to be applied to the uplink signal or the downlink signal from the selected parameter set; and
performing the transmission of the uplink signal or the reception of the downlink signal using the selected radio parameter.

9. A signal transmission or reception method in a base station, comprising the steps of:
selecting a parameter set from a parameter set group generated by grouping radio parameters used for reception of an uplink signal or transmission of a downlink signal;
selecting a radio parameter to be applied to the uplink signal or the downlink signal from the selected parameter set; and
performing the reception of the uplink signal or the transmission of the downlink signal using the selected radio parameter.

10. The user equipment according to claim 2,
wherein the transceiver receives the downlink signal including downlink control information scrambled using an identifier specific to the selected parameter set.

11. The user equipment according to claim 3,
wherein the transceiver receives the downlink signal including downlink control information scrambled using an identifier specific to the selected parameter set.
